(19) United States
(12) Patent Application Publication
(10) Pub. No.: US 2021/0318202 A1
(43) Pub. Date: Oct. 14, 2021

(54) METHOD AND SYSTEM FOR PROVIDING AN EXTENSIBLE MULTI-SOLUTION PLATFORM FOR SUBSEA LEAK DETECTION (SSLD)

(71) Applicant: Hecate Software, Inc., Richland, WA (US)

(72) Inventors: Ronald B. Livesay, Richland, WA (US); Eric A. Livesay, Richland, WA (US)

(21) Appl. No.: 17/228,430

(22) Filed: Apr. 12, 2021

Related U.S. Application Data
(60) Provisional application No. 63/008,083, filed on Apr. 10, 2020.

(51) Int. Cl. G01M 3/38; G01M 3/28; G01M 3/00; G01M 3/40; G06N 20/00; G06F 21/44; G06F 21/60

(52) U.S. Cl. CPC G01M 3/38; G01M 3/2815; G01M 3/002; G06F 21/602; G06N 20/00; G06F 21/44; G01M 3/40

(57) ABSTRACT

Provided is a subsea leak detection system, including a plurality of sensors mounted on a subsea structure; a data server configured to store data from the plurality of the sensors, wherein: the data server store the data in an encrypted format; and a controller configured to analyze the data in the data server in real-time, wherein the controller compares the data to an acceptable range to detect characteristic of a leak.

### CROSS-REFERENCE TO RELATED APPLICATIONS

This patent claims the benefit of U.S. Provisional Patent Application 63/008,083, filed 10 Apr. 2020, titled A METHOD AND SYSTEM FOR PROVIDING AN EXTENSIBLE MULTI-SOLUTION PLATFORM FOR SUBSEA LEAK DETECTION (SSLD). The entire content of this application is hereby incorporated by reference for all purposes.

### BACKGROUND

### 1. Field

The present disclosure relates generally to detection of abnormalities of measured values that are characteristic with leakage in subsea structures related to oil and gas production.

### 2. Description of the Related Art

In the oil and gas industry, production may take place for years or decades. Ever present is the need to detect leaks in the system of components that contain produced fluids (e.g. oil, gas and water) as they make their way from the underground reservoirs that has been their home for millions of years to the refinery. Recent leaks¹ in subsea components has led to a push for more sensitive technologies for leak detection to be developed. Such technologies may be focused on observed rate of change of measured values (e.g. the pressure of the produced fluid at certain locations in the aforementioned system of components). There are a wide variety of possible ‘leak detection algorithms’. In some of the embodiments of this disclosure, systems and methods for running multiple types of algorithms simultaneously is presented. ¹ BSEE Panel Report 2019-20, Investigation of Oct. 11, 2017 Flowline Jumper Failure, Lease OCS-G 24055 Mississippi Canyon Block 209 Gulf of Mexico Region, New Orleans District, Dec. 30, 2019.

### SUMMARY

The following is a non-exhaustive listing of some aspects of the present techniques. These and other aspects are described in the following disclosure.

Some aspects include a subsea leak detection system, including a plurality of sensors mounted on a subsea structure; a data server configured to store data from the plurality of the sensors, wherein: the data server store the data in an encrypted format; and a controller configured to analyze the data in the data server in real-time, wherein the controller compares the data to an acceptable range to detect characteristic of a leak.

Some aspects include a computer-implemented method for detecting anomalous behavior related to a leakage in a subsea structure.

### BRIEF DESCRIPTION OF THE DRAWINGS

The above-mentioned aspects and other aspects of the present techniques will be better understood when the present application is read in view of the following figure in which like numbers indicate similar or identical elements:

FIG. 1 is a block logical and physical architecture diagram showing an embodiment of a system for detecting suspected leakage in accordance with some of the present techniques;

FIG. 2 is a flowchart showing an example of a process by which leakage detection system may be performed in accordance with some of the present techniques;

FIG. 3 is a screenshot of an embodiment of a remote monitoring system detecting a potential leak in well #4;

FIG. 4 is a chart showing measured pressure (e.g. via pressure transmitters) versus time (left-side Y axis) and the rate of change of measured pressure vs time (right-side Y axis) in an offshore production facility; and

FIG. 5 illustrates an example of a computing device by which the present techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of fluid mechanics. Indeed, the inventors wish to emphasize the difficulty of monitoring pressure profiles in subsea pipelines and detecting potential leaks. Further, because multiple problems are addressed, it should be understood that some embodiments are problem-specific, and not all embodiments address every problem with traditional systems described herein or provide every benefit described herein. That said, improvements that solve various permutations of these problems are described below.

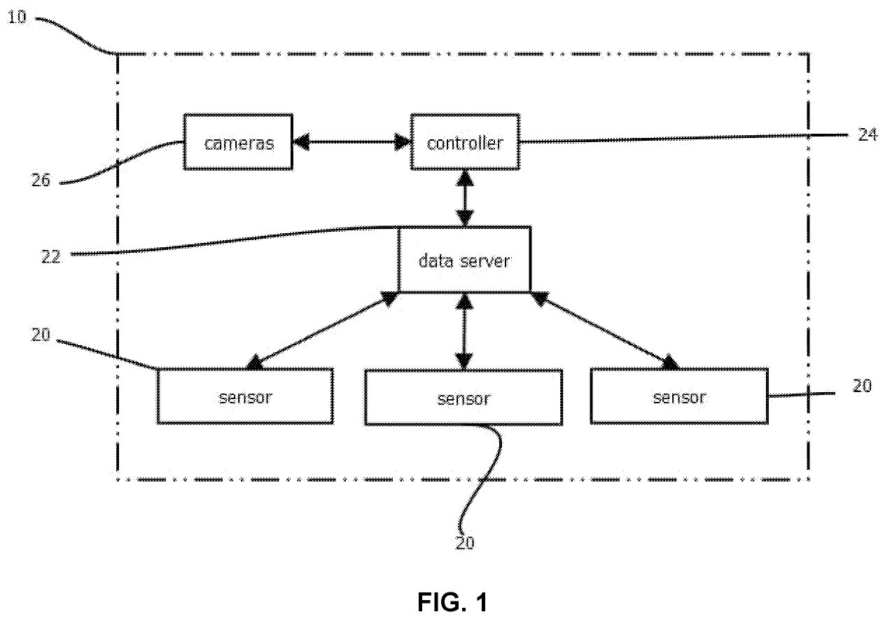

In some embodiments, a system for detecting potential leakage is described for a subsea facility or structure (e.g. a subsea oil and gas production, drilling or storage facility, etc.). FIG. 1 is a block logical and physical architecture diagram showing an embodiment of system for detecting potential leakage 10 that may include a series of sensors 20, a data server 22, and a controller 24. In some embodiments, the system 10 may further include other monitoring systems such as cameras 26.

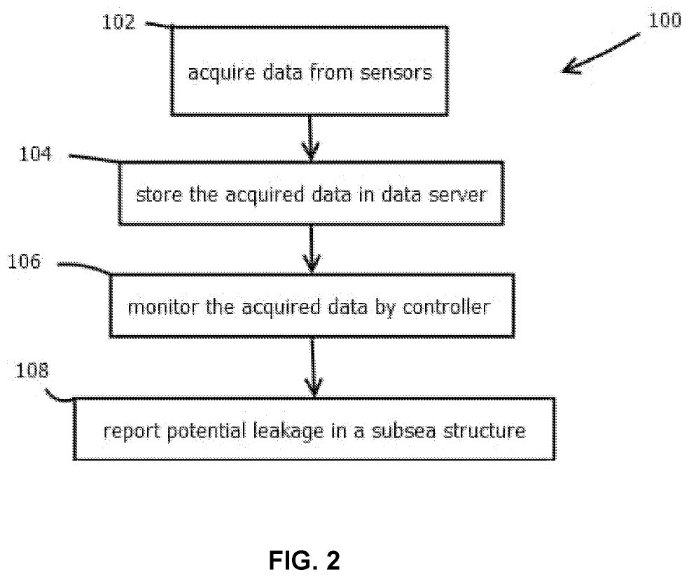

In some embodiments, the system of detecting potential leakage 10 may be configured to execute the process 100 described below with reference to FIG. 2. In some embodiments, different subsets of this process 100 may be executed by the illustrated components of the system of detecting potential leakage 10, so those features are described herein concurrently. It should be emphasized, though, that embodiments of the process 100 are not limited to implementations with the architecture of FIG. 1, and that the architecture of FIG. 1 may execute processes different from that described with reference to FIG. 2, none of which is to suggest that any other description herein is limiting.

In some embodiments, a series of sensors 20 may be employed to detect potential leakage in a subsea structure, as shown by block 102 in FIG. 2. The sensors 20 may be any type of sensor that may be employed to detect behavior potentially associated with the leakage of a fluid (e.g. water, hydrocarbons, chemicals, hydraulic fluids, etc.) running through the subsea structure (e.g. annulus, wellhead, manifolds, jumpers, flow lines, topside components, pipelines, etc.). The series of sensors 20 may include various types of sensors such as pressure sensors, acoustic sensors, temperature sensors, fluorescence sensors, gas sensors, imaging sensors, etc., or any combination of such sensors. Sensors may be positioned at various locations within the subsea structure to monitor and detect potential leakage within the structure. The positioning and operation of sensors in a subsea structure are well known to those skilled in the art. In some embodiments, at least some of the sensors are permanently mounted on various portions of the subsea structure. In some embodiments, sensors may be mounted on the subsea structure temporarily to more closely monitor signals associated with potential leaks.

In some embodiments, the data from the series of sensors 20 is received and stored by a data server 22, as shown by block 104 in FIG. 2. In some embodiments, data server 22 may receive additional data (e.g. other operational data such as flow rate, previous measured data, measured data from another subsea structure, simulated data, etc.) from an external source. In some embodiments, the series of sensors 20 may be connected to the data server 22 via wire or wireless connection.

In some embodiments, the data server 22 may store the data in encrypted format. The incoming data from the series of sensors 20 may be first encrypted and then stored. Once encrypted data is being retrieved by a controller 24, the controller 24 may be first authenticated by the data server 22 and upon successful authentication, the decrypted data will be sent to the controller 24 for further processing. In some embodiments, the incoming data from the series of sensors 20 may be stored in a binary format (e.g. Alarm.hekat).

In some embodiments, a controller 24 may be used to process the data stored in the data server 22, as shown by block 106 in FIG. 2. In some embodiments, the controller 24 is used to set a protocol for the series of sensors 20 or to change a pre-established protocol. Such a protocol may include information regarding the frequency of measurements for each of the sensors (e.g. measurements to occur every 0.001, 0.1, 1, 60, 3,600, 86,400 seconds), acceptable ranges of sensed variables (e.g. pressure within 1-5, 0.1-10, or 1-15 psi), the order in which the sensors measure the data (e.g. in parallel, in series, or a combination of both), and some emergency plans. For example, if behavior characteristic of a leak is detected in a portion of the subsea structure, sensors may start to measure data in shorter frequencies (e.g. more measurements). In some embodiments, a protocol provided by the controller may include fixed parameters (e.g. fixed intervals between each measurement) or variable parameters that may change (e.g. based on the recent received data). In some embodiments, a protocol provided by the controller may include an acceptable level of variation between the set value and the sensed value by the sensors.

In some embodiments, various levels of acceptable variations may be defined. For example, a protocol may include a first level of acceptable variations, where the controller does not take any further actions, a second level of acceptable variations, where the controller increases the frequency of measurements, and a third level of acceptable variations, where the controller sends an alarm to a human operator to take a close look. In some embodiments, if the sensed value is outside any defined acceptable variations, the controller may declare a state of emergency or shut down the whole operation.

In some embodiments, if a sensed value is outside the acceptable level of variation, the controller may direct the sensors (e.g. all sensors, sensors in the vicinity of the location assigned with the sensed value outside the acceptable level of variation, etc.) to measure the data more frequently to monitor potential leaks. In some embodiments, if a sensed value is outside the acceptable level of variation, the controller may direct some additional sensors and other means (e.g. temporary sensors, offline sensors, cameras, underwater drones, etc.) to measure data or further investigate potential leak. In some embodiments, if a sensed value is outside the acceptable level of variation, the controller may take further actions such as shutting down the operation, closing down the line suspected of leaking, reducing the flow rate within the line suspected of leaking, activate some emergency protocols, etc. In some embodiments, if a sensed value is outside the acceptable level of variation, the controller may direct the corresponding sensor to take another measurement to make sure the unacceptable sensed value is not a wrong measurement before taking any further actions. In some embodiments, if a sensed value is outside the acceptable level of variation, the controller may alarm a human operator to take a closer look and investigate potential leakage.

In some embodiments, a controller 24 may simultaneously monitor incoming data from pressure sensors, temperature sensors, and flow rate sensors to detect signals characteristic of potential leaking in a subsea structure. In some embodiments, the compensated pressure changes (i.e., variation in the measured pressure while taking into account the changes in the temperature and flow rate) may be monitored by the controller 24 to detect signals characteristic of potential leaks. In some embodiments, monitoring the compensated pressure changes may prevent false alarms because pressure changes may occur for reasons other than leakage that include but are not limited to things such as thermal expansion or contraction of the liquid, trapped vapor, adjustment of a valve position, adjustment of a choke position, and the physical changes pipe material itself.

In some embodiments, if a sensed value is outside of the predetermined acceptable range, the controller may generate an alert, automatically communicate an alert to a remote monitoring system or a human operator, or generate a report with maybe a time stamp, as shown by block 108 in FIG. 2. In some embodiments, a wide variety of possible methods of alerting a human operator, either on-location or monitoring remotely, may be via a system of color coded indicators; in some embodiments, red may be indicating detection of a signal that has such a strong possibility of being due to a leak that an automatic shut-in is imminent, orange (or yellow) may be indicating that a “signal of interest” exists which needs human investigation (although a shut-in is not imminent); green may be indicating there is no indication of a potential leak currently being observed nor is one currently predicted.

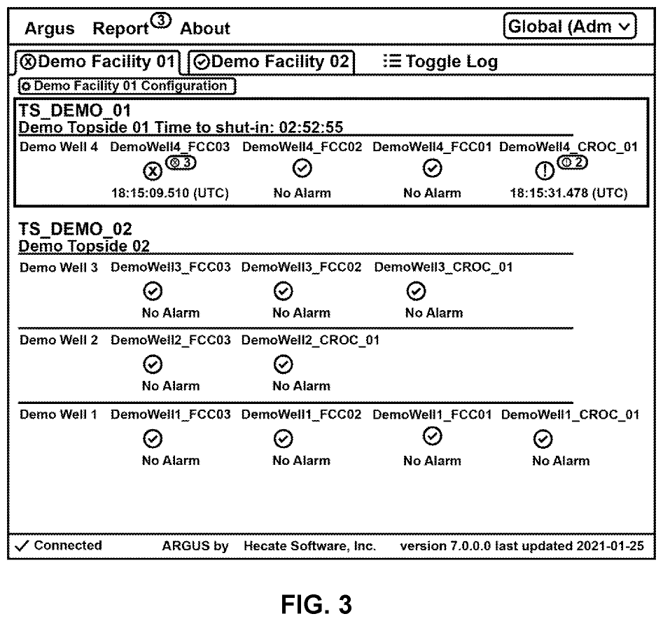

FIG. 3 is a screenshot of an embodiment of a remote monitoring system that has been reduced to practice which includes reporting for multiple sections (e.g. well #1, well #2, well #3, etc.) of a subsea structure into corresponding groups (e.g. group 1 named “TS_DEMO_01” which includes “Demo Well 4” and group 2 named “TS_DEMO_02” which includes “Demo Well 1”, “Demo Well 2” and “Demo Well 3”). In this embodiment, the controller is issuing only one alarm for well #4, specifically sensor #3 on well #4, wherein the potential leak is detected with a time stamp and projected timeline to shut down the flow in well #4. As it can be seen in FIG. 3, there is no alarm associated with well #1, #2, and #3.

In some embodiments, the controller 24 monitors the pressure drop in the line in order to detect signals characteristic of leaks in a pressurized subsea structure containing an incompressible fluid. If the pressure drops by more than a specified amount over a given period, the controller 24 may issue an alarm regarding a potential leak.

In some embodiments, a controller 24 may be used to monitor multiple subsea structures simultaneously for potential leaks. A controller may divide a subsea structure into multiple sections (e.g. well #1, well #2, well #3, etc.) and categorize the series of sensors, monitoring different sections, into corresponding groups (e.g. group 1 corresponding to well #1, group 2 corresponding to well #2, group 3 corresponding to well #3, etc.). A controller may divide a subsea structure into multiple flow lines (e.g. flow line #1, flow line #2, flow line #3, etc.) and categorize the series of sensors, monitoring different sections, into corresponding groups (e.g. group 1 corresponding to flow line #1, group 2 corresponding to flow line #2, group 3 corresponding to flow line #3, etc.).

In some embodiments, a controller 24 may predict false alarms by monitoring all the sections collectively. For example, if the flow is moving from section #1 to section #2 and a potential leak is detected in section #1, sensors mounted on section #2 will show a potential leak too because of the loss of the flow in section #2; however, the controller may be configured to calculate the amount of loss in section #2 and if the amount of loss in section #2 is the same as the amount of loss in section #1, the controller may assume there is no leak in section #2 and therefore the controller may not declare a potential leak in section #2 to prevent a false alarm.

In some embodiments, a controller 24 may predict leak alarms by monitoring all the sections collectively. For example, if the flow is moving from section #1 to section #2 and the maximum acceptable pressure in section #1 is 10 psi and maximum acceptable pressure in section #2 is 8 psi, once the pressure in section #1 goes above 8 psi, the controller may predict a potential leak in section #2 because the flow will be transferred from section #1 to section #2 and the controller may take precautionary measures to prevent potential damage followed by a potential leak in section #2. Such precautionary measure may include alarming a human operator, reducing the flow rate in section #1, shutting down the flow before it reaches to section #2, etc.

In some embodiments, a controller 24 may apply machine-learning techniques to learn from previous detected leakage and predict potential future leakage in advance. Some embodiments afford machine-learning systems that implement Bayesian statistics, a branch of mathematics that employs “degrees of belief” to interpretations of probability, to create algorithms that make predictions on data. Some embodiments identify patterns of previous detected leakage across multiple (e.g., 2 or more, 3 or more, 5 or more, 10 or more, or 40 or more) variables (e.g pressure, temperature, flow rate, composition of the flow, etc.) to predict the future potential leakage in the entire system. By looking back at past known leakage incidents and applying the lessons learned, the controller may predict an upcoming leakage incident by matching instances of similar incidents stored in the data server 22. Furthermore, the controller 24 may provide solutions to be accessed in real-time to provide a helpful guide for human operators to prevent an imminent leakage incident (e.g. occurring in 1, 5, 30, 60, 180, or 360 minutes).

In some embodiments, a controller 24 may provide an alert and recommend remedial measures regarding possible leakage in a subsea structure. Remediation of a detected, possible leakage may be automated, manual, or may solicit user or administrator involvement.

In some embodiments, a controller 24 may be configured to perform an operation that includes: training a machine learning model to detect an anomaly, detected by a sensor mounted on a unit of a subsea structure, that is present and/or developing in the unit; detecting the anomaly in the unit by at least processing, with a trained machine learning time series model, one or more performance metrics for the unit (e.g. acceptable ranges for operational parameters such as pressure, temperature, flow rate, etc.); and in response to detecting the presence of the anomaly at the unit: determining one or more remedial actions for correcting and/or preventing the anomaly at the unit. In some embodiments, the controller may rank the remedial actions in order of importance to help minimizing the possible damages (e.g. amount of loss in the leakage, extend physical damage to the structure, etc.).

Some embodiments mitigate a leakage monitoring system using an unsupervised multivariate anomaly detection method based on Generative Adversarial Networks (GANs) that considers the entire variable set (e.g. data received from the sensors) concurrently to capture the latent interactions amongst the variables. Some embodiments mitigate a leakage monitoring system using a real-time anomaly detection algorithm based on Hierarchical Temporal Memory (HTM) and Bayesian Network (BN).

In some embodiments, a controller 24 may detect anomalies and predict imminent leakage (e.g. occurring in 1, 5, 30, 60, 180, or 360 minutes) in advance for each instrument or machine in a subsea structure. For instance, a typical pump could have multiple sensors to measure various values, including vibration (drive-end and non drive-end), flow rate, pressure (differential and suction), temperature (pump housing, pool, drive-end bearing, non drive-end bearing, etc.), speed and motor-absorbed power. Some or all of these values (and others, depending on the pump application) may vary widely during normal operating behaviors over a wide range of field conditions and operating modes. In some embodiments, the controller 24 is configured to monitor these values collectively to predict potential leakage in a subsea structure.

Some embodiments mitigate training a machine learning model to evaluate the archived data from a system for monitoring for potential leakage, testing it, retraining it if necessary until satisfactory results are achieved, and then evaluate it on a hold out data set. After the model's performance is satisfactory, then the system can be deployed on a real production facility. Once in production, the system scores new data as it comes in. Eventually after a few months, the system can update the model if a significant amount of new training data comes in. Model training is a one-time activity, or done at most at periodic intervals to maintain the model's performance to take into account new information. In some embodiments, a machine learning model may be trained based on the previous incidents of known leakage in a subsea structure and the operational conditions associated with those incidents. For example, if a leakage has occurred in the past in a pump once the pressure surpassed 5 psi, the trained model may predict an upcoming leakage incident is the pressure shows an increasing trend and approaching the 5 psi limit.

In some embodiments, a controller 24 may be configured to perform an operation that includes use of an algorithm to predict future behavior using methods of numerical extrapolation of data to predict the future detection of an anomaly that will be detected by a sensor mounted on a unit of a subsea structure, that is present or developing in the unit; detecting the anomaly in the unit by at least processing, with numerical extrapolation method, one or more performance metrics for the unit (e.g. acceptable ranges for operational parameters such as pressure, temperature, flow rate, etc.); and in response to detecting the presence of the anomaly at the unit: determining one or more remedial actions for correcting and/or preventing the anomaly at the unit. In some embodiments, the controller may rank the remedial actions in order of importance to help minimizing the possible damages (e.g. amount of loss in the leakage, extend physical damage to the structure, etc.).

In some embodiments, a controller 24 may detect anomalies and predict imminent leakage in advance, for each instrument or machine in a subsea structure, by monitoring rate of change of operational parameters such as pressure, temperatures, flow rate, etc. For example, the controller may calculate and monitor the rate of change of the flow pressure measured by the sensors (e.g. pressure transmitters) at a subsea sled or manifold header. If the pressure rate of change exceeds a certain threshold and is in the direction of hydrostatic pressure, a significant leak may have occurred in the subsea system and the controller may issue an alarm, indicating potential leak.

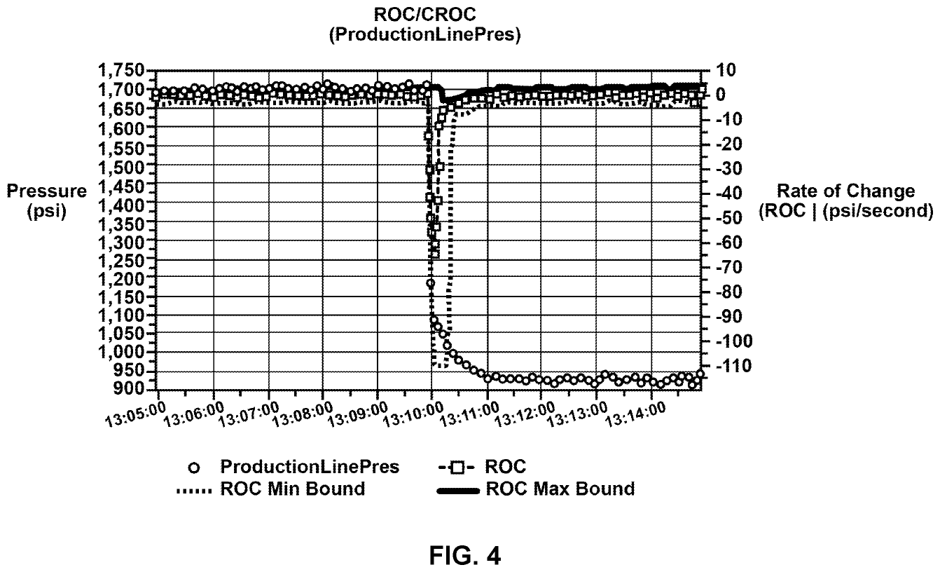

FIG. 4 shows measured pressure (e.g. via pressure transmitters) versus time (left-side Y axis) and the rate of change of measured pressure vs time (right-side Y axis) in an offshore production facility. A protocol was used by the controller to set an acceptable range for the rate of change of measured pressure. As it can be seen, at 13:10 (1:10 pm) the rate of change of measured pressure dropped below the acceptable range; in response, the controller issued an alarm and shut down the line to prevent further leakage and potential damage.

In some embodiments, the techniques and systems, described in this disclosure, may be used for other fields of security, monitoring, or surveillance systems. For example, the teaching of some of the embodiments of this disclosure may be used to monitor facilities other than subsea structures (e.g. refineries, commercial and institutional buildings, office Buildings, hospitals, hotels, restaurants, educational facilities, industrial, etc.) In some embodiments, the techniques and systems, described in this disclosure, may be used for applications other than potential leakage, including trespassing, explosion, unauthorized entrance, power outage, internet connection, etc.

In some embodiments, a series of cameras may be used to monitor potential leakage in a subsea structure. Cameras may be permanently affixed to some portion of the subsea structure or may be temporarily used to monitor a portion of a subsea structure (e.g. underwater drones).

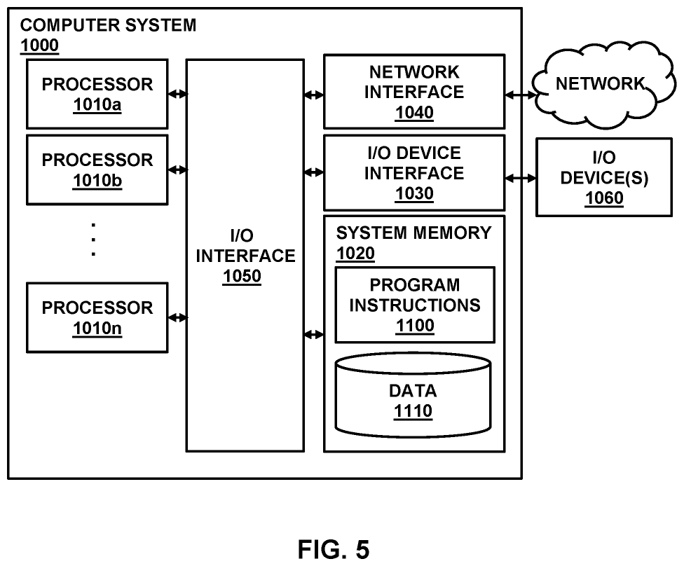

FIG. 5 is a diagram that illustrates an exemplary computing system 1000 by which embodiments of the present technique may be implemented. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the figures are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. In this patent, certain U.S. patents, U.S. patent applications, or other materials (e.g., articles) have been incorporated by reference. The text of such U.S. patents, U.S. patent applications, and other materials is, however, only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:
1. A subsea leak detection system, comprising a plurality of sensors mounted on a subsea structure; a data server configured to store data from the plurality of the sensors, wherein: the data server store the data in an encrypted format; and a controller configured to analyze the data in the data server in real-time, wherein the controller compares the data to an acceptable range to detect characteristic of a leak.
2. The system of claim 1, wherein the data server authenticates the controller before providing the data to the controller for analysis.
3. The system of claim 2, wherein upon successful authentication of the controller, the data server is configured to decrypt the stored encrypted data before sending it to the controller.
4. The system of claim 1, further comprising: a plurality of cameras mounted on a subsea structure to monitor for potential leaks.
5. The system of claim 4, wherein the controller is configured to instruct at least some of the plurality of cameras to check for potential leaks once measured data is out of the acceptable range.
6. The system of claim 1, wherein the acceptable range is defined by a human operator.
7. The system of claim 1, wherein the controller is configured to obtain, with one or more processors, one or more datasets from the data server and train, with one or more processors, a predictive machine learning model to predict potential leaks in the subsea structure, wherein the trained model is configured to make predictions based on the data from the plurality of the sensors.
8. The system of claim 1, wherein the acceptable range is defined by the trained model.
9. The system of claim 1, wherein the plurality of sensors comprises at least two types of the following sensors: temperature sensors; pressure sensors; temperature sensors; fluorescence sensors; vibration sensors; and capacitive sensors.
10. The system of claim 1, wherein the subsea leak detection system is configured to remotely monitor the subsea structure from a height in the range 50 to 100 meter above the water level.
11. The system of claim 1, wherein controller is configured to use a numerical extrapolation to predict a leakage in the near future.
12. A method for detection of potential subsea pipeline leaks comprising: obtaining, with one or more processors, data from a plurality of sensors mounted on a subsea structure; storing, with one or more processors, the data in a data server, wherein the stored data is in an encrypted format; and determining potential leakage in the subsea structure, with one or more processors, via a controller in real time by comparing the data with an acceptable range.
13. The method of claim 12, wherein the data server authenticates the controller before providing the data to the controller.
14. The method of claim 13, wherein upon successful authentication of the controller, the data server is configured to decrypt the stored encrypted data before sending it to the controller.
15. The method of claim 12, further comprising: a plurality of cameras mounted on a subsea structure to monitor for potential leaks.
16. The method of claim 15, wherein the controller is configured to instruct at least some of the plurality of cameras to check for potential leaks once the data is out of the acceptable range.
17. The method of claim 12, wherein the acceptable range is defined by a human operator.
18. The method of claim 12, wherein the controller is configured to obtain, with one or more processors, one or more datasets from the data server and train, with one or more processors, a predictive machine learning model to predict leak in the subsea structure, wherein the trained model is configured to make predictions based on the data from the plurality of the sensors.
19. The method of claim 12, wherein the acceptable range is defined by the trained model.
20. The method of claim 12, wherein the plurality of sensors comprises at least two types of the following sensors temperature sensors; pressure sensors; temperature sensors; fluorescence sensors; vibration sensors; and capacitive sensors.
21. The method of claim 12, wherein the subsea leak detection system is configured to remotely monitor the subsea structure from a height in the range 50 to 100 meter above the water level.

What is claimed is:

1. A subsea leak detection system, comprising:
a plurality of sensors mounted on a subsea structure;
a data server configured to store data from the plurality of the sensors, wherein:
the data server store the data in an encrypted format; and
a controller configured to analyze the data in the data server in real-time, wherein the controller compares the data to an acceptable range to detect characteristic of a leak.

2. The system of claim 1, wherein the data server authenticates the controller before providing the data to the controller for analysis.

3. The system of claim 2, wherein upon successful authentication of the controller, the data server is configured to decrypt the stored encrypted data before sending it to the controller.

4. The system of claim 1, further comprising:
a plurality of cameras mounted on a subsea structure to monitor potential leaks.

5. The system of claim 4, wherein the controller is configured to instruct at least some of the plurality of cameras to check for potential leaks once the data is out of the acceptable range.

6. The system of claim 1, wherein the acceptable range is defined by a human operator.

7. The system of claim 1, wherein the controller is configured to obtain, with one or more processors, one or more datasets from the data server and train, with one or more processors, a predictive machine learning model to predict a leakage in the subsea structure, wherein the trained model is configured to make predictions based on the data from the plurality of the sensors.

8. The system of claim 1, wherein the acceptable range is defined by the trained model.

9. The system of claim 1, wherein the plurality of sensors comprises at least two types of the following sensors:
temperature sensors;
pressure sensors;
temperature sensors;
fluorescence sensors;
vibration sensors; and
capacitive sensors.

10. The system of claim 1, wherein the subsea leak detection system is configured to remotely monitor the subsea structure from a height in the range 50 to 100 meter above the water level.

11. The system of claim 1, wherein controller is configured to use a numerical extrapolation to predict a leakage in the near future.

12. A method for detection of potential leakage form subsea pipeline comprising:
obtaining, with one or more processors, data from a plurality of sensors mounted on a subsea structure;
storing, with one or more processors, the data in a data server, wherein the stored data is in an encrypted format; and
determining a leak in the subsea structure, with one or more processors, via a controller in real time by comparing the data with an acceptable range.

13. The method of claim 12, wherein the data server authenticates the controller before providing the data to the controller.

14. The method of claim 12, wherein upon successful authentication of the controller, the data server is configured to decrypt the stored encrypted data before sending it to the controller.

15. The method of claim 12, further comprising:
a plurality of cameras mounted on a subsea structure to monitor for potential leaks.

16. The method of claim 15, wherein the controller is configured to instruct at least some of the plurality of cameras to check for potential leaks once the data is out of the acceptable range.

17. The method of claim 12, wherein the acceptable range is defined by a human operator.

18. The method of claim 12, wherein the controller is configured to obtain, with one or more processors, one or more datasets from the data server and train, with one or more processors, a predictive machine learning model to predict leak in the subsea structure, wherein the trained model is configured to make predictions based on the data from the plurality of the sensors.

19. The method of claim 12, wherein the acceptable range is defined by the trained model.

20. The method of claim 12, wherein the plurality of sensors comprises at least two types of the following sensors:
temperature sensors;
pressure sensors;
temperature sensors;
fluorescence sensors;
vibration sensors; and
capacitive sensors.
